(19) United States
(12) Patent Application Publication
(10) Pub. No.: US 2016/0250756 A1
(43) Pub. Date: Sep. 1, 2016

(54) GRIPPING DEVICE FOR A CO-HANDLING ROBOT, AND CO-HANDLING ROBOT EQUIPPED WITH SUCH A DEVICE

(71) Applicant: COMMISSARIAT A L'ENERGIE ATOMIQUE ET AUX ENERGIES ALTERNATIVES, Paris (FR)

(72) Inventors: Frederic COLLEDANI, Massy (FR); Benoit PEROCHON, Guyancourt (FR)

(73) Assignee: COMMISSARIAT A L'ENERGIE ATOMIQUE ET AUX ENERGIES ALTERNATIVES, Paris (FR)

(21) Appl. No.: 15/030,187

(22) PCT Filed: Nov. 6, 2014
(86) PCT No.: PCT/EP2014/073897

§ 371 Date: Apr. 18, 2016

(30) Foreign Application Priority Data
Nov. 14, 2013 (FR) 13 61135

(51) Int. Cl. B25J 15/06; B25J 13/08; B25J 1/02

(52) U.S. Cl. CPC B25J 15/06; B25J 1/02; B25J 13/084

(57) ABSTRACT

The invention relates to a gripping device (5) comprising a gripping member (10) designed to come into contact with an object to be manipulated (100) and control means for controlling a joining and a separation of the gripping member and the object to be manipulated, the control means being associated with a contact (16) able to generate a joining and/or separating control signal intended for the control means when the contact is activated. According to the invention, the gripping member is slidably mounted in the device between a non-pushed-in position and a pushed-in position, the contact being positioned in the device so as to be activated by the gripping member when the gripping member is in the pushed-in position. The invention also relates to a co-handling robot comprising such a device.

The invention relates to a gripping device for a co-handling robot and a co-handling robot equipped with such a device.

### TECHNICAL BACKGROUND OF THE INVENTION

There are existing co-handling robots, also called cobots or force assistance machines, which can be used to assist operators in various tasks. These co-handling robots have proved useful, in particular, for helping operators to handle heavy loads or to handle lighter loads in a rapid and repetitive manner.

Such a co-handling robot includes, for example, a gripping device comprising a pick-up member intended to come into contact with an object to be handled and means for controlling the attachment and detachment of the pick-up member and the object to be handled, the control means being associated with a contact switch capable of generating a control signal for the attachment and detachment, to be sent to the control means when the contact switch is activated.

The contact switch is usually a button or a lever mounted on a handle for the manipulation of the pick-up member.

Thus, in order to attach the pick-up member and the object to one another, the operator must make the pick-up member approach the object. When the pick-up member is in contact with the object, the operator can then activate the contact switch. Similarly, in order to detach the pick-up member and the object from one another, the operator must place the object on a support. When the object is in contact with the support, the operator can then activate the contact switch.

However, it is difficult for the operator to make the pick-up member approach the object to be lifted while he is controlling the contact switch. Similarly, it has proved difficult for the operator to make the object to be released approach the support while he is controlling the remote contact switch.

### OBJECT OF THE INVENTION

One object of the invention is to propose a gripping device for a co-handling robot by means of which an object to be handled by said gripping device can be grasped and/or released more easily, preferably while reducing the mental load of the operator.

### BRIEF DESCRIPTION OF THE INVENTION

In order to achieve this object, a gripping device for a co-handling robot is proposed, comprising a pick-up member, intended to come into contact with an object to be handled, and means for controlling the attachment and detachment of the pick-up member and the object to be handled, the control means being associated with a contact switch capable of generating a control signal for attachment and/or detachment, to be sent to the control means when the contact switch is activated.

According to the invention, the pick-up member is mounted slidably in the device between a non-depressed position and a depressed position, the contact switch being positioned in the device so as to be activated by the pick-up member when the pick-up member is in the depressed position, the pick-up member being kept in a non-depressed position when the object is suspended on the pick-up member.

Because of the interaction between the contact switch and the pick-up member, the operator can exclusively control the pick-up member and its position facing the object or facing a support on which the object rests, or on which the object is to be deposited. This is because, by pressing the pick-up member onto the object and/or by pressing the object onto the support, the operator automatically causes the pick-up member to move from its non-depressed position to its depressed position, and therefore causes a control signal for attachment and/or detachment to be sent via the contact switch.

The attachment and/or the detachment of the pick-up member and the object to or from one another is thus simple and rapid. The control of the pick-up member is therefore intuitive and particularly user-friendly.

A co-handling robot comprising a gripping device according to the invention is also proposed.

### BRIEF DESCRIPTION OF THE DRAWINGS

The invention will be understood more readily in the light of the following description of particular nonlimiting embodiments of the invention.

Reference will be made to the attached figures, of which:

FIG. 1 is a schematic view of a co-handling robot comprising a gripping device according to the invention,

FIG. 2 shows the gripping device of FIG. 1 when the pick-up member is in the non-depressed position,

FIG. 3 shows the gripping device of FIG. 2 when the pick-up member is in the depressed position.

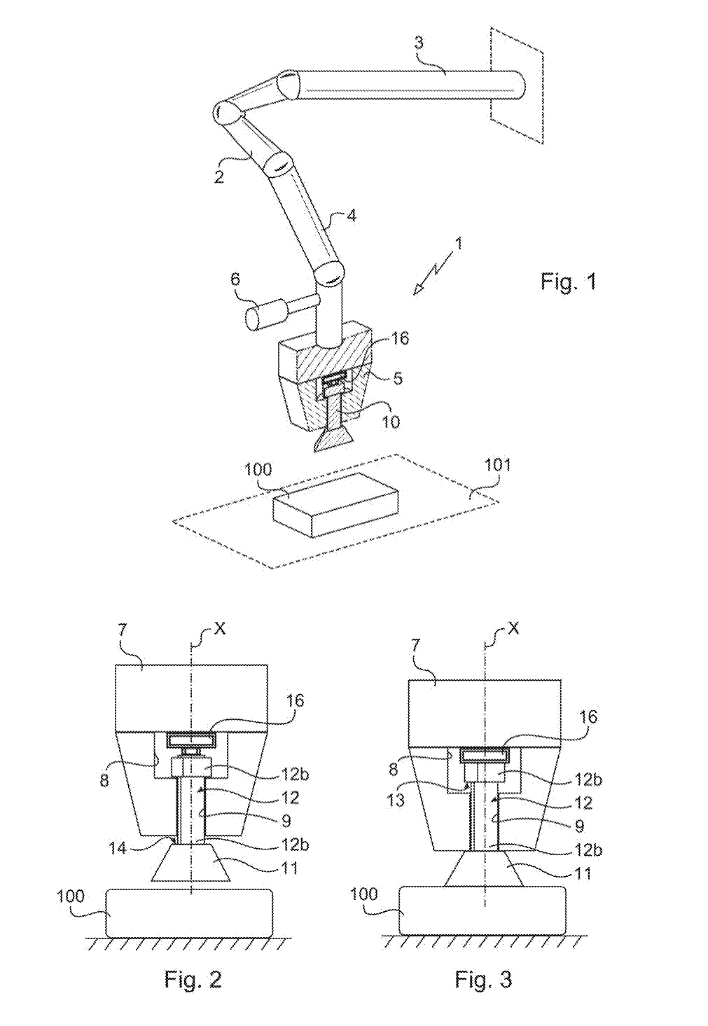

### DETAILED DESCRIPTION OF THE INVENTION

With reference to the figures, the co-handling robot 1 according to the invention here comprises an articulated arm 2, whose first end 3 is fixed, while its second end 4 is joined to a gripping device 5 according to the invention.

Preferably, the gripping device 5 comprises a handle 6 enabling an operator to move the gripping device 5 by means of the articulated arm 2.

The gripping device 5 here comprises a body 7 in which a chamber 8 is formed. The body 7 also comprises an aperture 9 extending in a direction X through the body 7 between the chamber 8 and the outside of the body 7.

The device further comprises a pick-up member 10 intended to come into contact with an object 100 to be handled, the object 100 here resting on a support 101. According to a particular embodiment, the pick-up member 10 comprises a suction cup 11 intended to come into contact with the object 100 and a rod 12, of which one end 12a is connected to the suction cup and the other end 12b is free.

According to a particular embodiment, the suction cup 11 is of the magnetic type; that is to say, the suction cup 11 comprises means for generating a magnetic field, which, when the suction cup 11 is activated, generate a magnetic field enabling the object 100 to be attached to the suction cup 11.

The pick-up member 10 is arranged in the gripping device in such a way that the rod 12 is mounted slidably in the aperture 9 between a non-depressed position (as shown in FIG. 2) and a depressed position (as shown in FIG. 3). The pick-up member 10 comprises a first stop defining the non-depressed position of the pick-up member. For this purpose, the rod 12 comprises a shoulder 13 interacting with a wall of the chamber 8, to stop the travel of the rod 12 through the aperture 9 and thus define the non-depressed position. The pick-up member 10 is shaped so that, in a non-depressed position, the free end 12b of the rod 12 is positioned in the chamber 8 and the suction cup 11 is positioned outside the body 7.

Preferably, the pick-up member 10 further comprises a second stop for defining the depressed position of the pick-up member 10. For this purpose, the suction cup 11 comprises a flat surface 14 opposite the surface of the suction cup intended to come into contact with the object 100, the flat surface 14 having an area greater than a cross section of the aperture 9. The flat surface thus interacts with a wall of the body 7, to stop the travel of the rod 12 through the aperture 9 and thus define the depressed position.

The device further comprises means (not shown here) for controlling the attachment and detachment of the pick-up member 10 and the object 100. Thus the control means control the activation of the suction cup 11, thereby allowing the generation of the magnetic field to be controlled.

Accordingly, the device comprises a contact switch 16 which is associated with the control means and which is capable of generating a control signal for the attachment and detachment, to be sent to the control means when the contact switch is activated.

According to the invention, the contact switch 16 is positioned in the device so as to interact with the pick-up member 10 when the pick-up member 10 is in the depressed position to enable a control signal to be generated at the control means. Preferably, the contact switch 16 is a push button having a first stable position in which the push button is pushed in and a second stable position in which the push button protrudes. According to a particular embodiment, the contact switch 16 is configured in such a way that the change from the second stable position to the first stable position causes a control signal for attachment to be transmitted to the control means, and in such a way that the change from the first stable position to the second stable position causes a control signal for detachment to be transmitted to the control means.

In this case, the contact switch 16 is positioned in the chamber 8, on a wall of the chamber 8 opposite the wall on which the aperture 9 opens, so that, when the pick-up member 10 is in the depressed position, the free end 12b of the rod 12 is in contact with the contact switch 16.

The operation of the device according to the invention will now be explained with reference to FIGS. 2 and 3.

When the operator wishes to attach the object 100 to the pick-up member 10, he manipulates the gripping device 5 so as to cause the suction cup 11 to be deposited on the object 100 resting on the support 101, thereby causing a movement of the rod 12 and consequently a movement of the pick-up member 10 from the non-depressed position to the depressed position. The free end 12b of the rod 12 then comes to bear on the contact switch 16, and, in turn, causes the contact switch 16 to move from its second stable position to its first stable position. The activation of the contact switch 16 causes a control signal for attachment to be transmitted to the control means. The control means then control the activation of the suction cup 11 so that it becomes activated: the magnetic field which is generated enables the object 100 to be attached to the suction cup 11.

The operator can then move the object 100 with the aid of the co-handling robot 1.

In the absence of contact between the object 100 and the support 101, the rod 12 moves again and the pick-up member 10 naturally returns to its non-depressed position where it is stopped, the object being suspended on the pick-up member 10.

When the operator wishes to detach the object 100 from the pick-up member 10, he handles the gripping device 5 so as to cause the object 100 to be deposited on the support 101, thereby causing a movement of the rod 12 and consequently a movement of the pick-up member 10 from the non-depressed position to the depressed position. The free end 12b of the rod 12 then comes to bear on the contact switch 16, and, in turn, causes the contact switch 16 to move from its first stable position to its second stable position. The activation of the contact switch 16 causes a control signal for detachment to be transmitted to the control means. The control means then control the activation of the suction cup 11 so that it ceases to be activated. In the absence of the magnetic field, the object 100 is detached from the suction cup 11.

The operator can then move the gripping device 5 on its own, with the aid of the co-handling robot 1.

In the absence of contact between the suction cup 11 and the object 100, the rod 12 moves again and the pick-up member 10 returns to its non-depressed position.

A new gripping cycle can then commence.

Thus the gripping device 5 according to the invention allows simple and rapid handling of the object by the operator.

Additionally, the second stop advantageously prevents the rod 12 from bearing too strongly on the contact switch 16, which could damage the latter.

Evidently, the invention is not limited to the embodiment that has been described, and variant embodiments thereof may be devised without departing from the scope of the invention as defined by the claims.

In particular, the pick-up member may be different from that described. Thus, although in this case the pick-up member comprises a suction cup of a magnetic type, the suction cup may be of a pneumatic type. The pick-up member may also comprise an electromagnet. In a variant, the pick-up member may comprise a gripper for gripping an object, in which case the control means control the opening and closing of the gripper to cause the detachment and attachment, respectively, of the gripper and the object.

The stops may have a different shape from that described. For example, the rod may comprise a groove in which an elastic ring is placed to form the stop. The stop may be carried by the body instead of by the rod.

Although in this case the interaction of the contact switch and the pick-up member is used to control both the attachment and the detachment of the pick-up member and the object, said interaction may be used to control only the attachment, or only the detachment. In this case, the control signal for detachment or attachment, respectively, will be generated by an external control, for example by a lever or a switch, controlled manually by the operator.

The contact switch may be different from that described. Thus the contact switch may have a different number of stable positions, and in particular a single stable position.

The device may also comprise means for checking the attachment and/or detachment of the object and the pick-up member. For this purpose, the checking means may comprise a pressure sensor or a pressure switch which is positioned in the cavity of the suction cup to determine whether the object is actually attached to the suction cup. The checking means may also comprise a feeler positioned on the pick-up member so that it can come into contact with the object and determine whether the object is actually attached to the suction cup.

Although in this case the pick-up member returns naturally to its non-depressed position, the pick-up member may comprise return means, comprising a spring for example, to bring the pick-up member back from its depressed position to its non-depressed position.

1. A gripping device for a co-handling robot, comprising a pick-up member intended to come into contact with an object to be handled and means for controlling the attachment and detachment of the pick-up member and the object to be handled, the control means being associated with a contact switch capable of generating a control signal for attachment and/or detachment to be sent to the control means when the contact switch is activated, the device being characterized in that the pick-up member is mounted slidably in the device between a non-depressed position and a depressed position, the contact switch being positioned in the device so as to be activated by the pick-up member when the pick-up member is in the depressed position, the pick-up member being kept in a non-depressed position when the object is suspended on the pick-up member.

2. The device as claimed in claim 1, wherein the contact switch is configured to generate a control signal for detachment and attachment to be sent to the control means when the contact switch is activated.

3. The device as claimed in claim 1, wherein the pick-up member comprises a suction cup intended to come into contact with the object and a rod, of which one end is connected to the suction cup and the other end is free, the free end being intended to come into contact with the contact switch in order to interact with said contact switch.

4. The device as claimed in claim 3, comprising a body in which a chamber is formed, the body also comprising an aperture extending through the body between the chamber and the outside of the body, the rod being mounted slidably in the aperture.

5. The device as claimed in claim 4, wherein the contact switch is positioned in the chamber, on a wall of the chamber opposite the wall on which the aperture opens, so that, when the pick-up member is in the depressed position, the free end of the rod is in contact with the contact switch.

6. The device as claimed in claim 4, wherein the pick-up member and/or the body comprises at least one stop for defining the depressed position of the pick-up member.

7. The device as claimed in claim 3, wherein the suction cup is of a magnetic type.

8. The device as claimed in claim 3, wherein the suction cup is of a pneumatic type.

9. The device as claimed in claim 1, wherein the pick-up member comprises a gripper, the control means being capable of controlling the opening and/or the closing of the gripper to cause the detachment and/or attachment, respectively, of the gripper and the object.

10. The device as claimed in claim 1, further comprising means for checking the attachment and/or detachment of the object and the pick-up member.

11. A co-handling robot comprising a gripping device as claimed in claim 1.
